(19) United States
(12) Patent Application Publication
(10) Pub. No.: US 2010/0145852 A1
(43) Pub. Date: Jun. 10, 2010

(54) METHODS AND SYSTEMS FOR MANAGING LOSS OR THEFT OF ATM CARDS

(75) Inventor: Chris Morson, Edinburgh (GB)

Correspondence Address: FRISHAUF, HOLTZ, GOODMAN & CHICK, PC, 220 Fifth Avenue, 16TH Floor, NEW YORK, NY, 10001-7708, US

(73) Assignee: THE ROYAL BANK OF SCOTLAND PLC, Edinburgh (GB)

(21) Appl. No.: 12/529,873

(22) PCT Filed: Mar. 7, 2008
(86) PCT No.: PCT/EP2008/052792

§ 371 Date: Jan. 20, 2010

(30) Foreign Application Priority Data
Mar. 7, 2007 (GB) 0704396.1
Oct. 15, 2007 (GB) 0720088.4

(51) Int. Cl. G06Q 40/00

(52) U.S. Cl. 705/43; 705/44

(57) ABSTRACT

Embodiments of the present invention relate to ways of processing the loss or theft of a an ATM card or the like including: reporting to a card provider that the card has been lost or stolen; authenticating the reported loss or theft and restricting the subsequent use of the card; and issuing a cash withdrawal code, which is usable for withdrawing an agreed amount of emergency cash from a cash dispensing machine without•requiring the use of a cash dispensing card, and storing the cash withdrawal code. Embodiments of the present invention thereby enable the card holder to withdraw cash in a situation where they may otherwise be without the facility to obtain cash while limiting or preventing the ability for anyone to misuse the card that has been reported as lost or stolen. Generating of issuing a PIN or code after the card was stolen or loss of said card.

### FIELD OF THE INVENTION

The present invention relates to methods and systems for managing the loss or theft of an automatic teller machine (ATM) card or the like and, in particular, for delivering emergency cash to a customer who has suffered the loss or theft.

### BACKGROUND OF THE INVENTION

Nowadays, people who are customers of banks or other financial institutions expect to have the facility to withdraw their cash from cash dispensing machines, which are often referred to as automatic teller machines (ATM), using an ATM card that has been issued to them by their bank or other card provider. ATMs are typically located in banks, but are also located in places such as stores, shopping malls, or indeed anywhere where people need the convenience of being able to withdraw their cash. Indeed, as a result of arrangements between banks, customers are often able to withdraw cash using ATMs belonging to other banks in their own or even in different countries, further increasing the convenience to customers.

Before the advent of ATMs, customers were mainly limited to being able to withdraw cash from a bank only during bank opening hours, which was extremely inconvenient.

If a customer loses their ATM card, or has it stolen, during an interim period before they receive a replacement card, they are no longer able to use ATMs to withdraw cash and they need to revert to visiting a bank during its opening hours in order to withdraw cash. If a customer is not near their bank, for example if they are on holiday abroad, it may not be practical to visit their own bank and it can be extremely difficult and inconvenient to arrange to transfer funds to, and withdraw cash from, a foreign bank.

Some banks offer a service whereby, if an ATM card is lost or stolen while the customer is abroad, the customer can inform the bank and the bank will issue a new card in a very short period of time, for example in under 48 hours, and even deliver the card directly to the customer by courier. Of course, the customer may be without any means of making payments in the meantime.

Aspects and embodiments of the present invention aim to provide alternative means for obtaining cash, for example, when an ATM card or the like has been lost or stolen.

### SUMMARY OF THE INVENTION

According to a first aspect, the present invention provides a method of processing a reported loss or theft of a cash dispensing token, comprising:
reporting to a token provider that a token has been lost or stolen;
authenticating the report and restricting the subsequent use of the token; and
issuing a cash withdrawal code, which is usable for withdrawing an agreed amount of emergency cash from a cash dispensing machine without requiring use of a cash dispensing token, and storing the issued cash withdrawal code.

In the present context, a cash dispensing token typically means an ATM card used for withdrawing cash from an ATM. The card may be a known magnetic stripe card and/or a known chip card or smart card, which contains an embedded microprocessor. In principle, however, a token also encompasses conceivable new kinds of smart card or other portable personal identity devices. Any such cards or devices may include contacts or, in addition or alternatively, may be contact-less, for example employing a proximity circuit, such as an RFID circuit, for supporting contact-less communications with an appropriately configured ATM. Such tokens need not be card-shaped and could, for example, take any suitable form; for example a key fob, a mobile phone, or another mobile or portable processing device. Accordingly, unless the context dictates otherwise, references to card hereinafter should not be taken to limit the embodiments of the invention to cards as such, and other kinds of token could equally be employed.

A benefit of this aspect of the present invention is that a customer can, for example, as part of a token cancellation procedure, arrange to withdraw emergency cash from an ATM even before a new token has been received. Under normal circumstances, if a customer loses his ATM token, he either has to visit a bank during opening hours, make special arrangements to obtain cash or, if the token has been lost, wait for a new token to be issued.

According to the prior art, a report of the loss or theft of a card typically led to the immediate cancellation of the card so that a new card could be issued (for example, to meet the needs of the customer), and to reduce the likelihood that a stolen card would be used by a fraudster (for example, to meet the security needs of the token provider).

According to embodiments of the present invention, the step of restricting may also comprise cancelling said token to prevent any subsequent use thereof. In that case, the step may include issuing a replacement cash dispensing token (or equivalent).

According to other embodiments of the present invention, however, the step of restricting may instead comprise suspending said token to prevent subsequent use thereof at least temporarily. By ‘suspension’ we mean the token cannot be used at an ATM machine, in the same way as if the token had been cancelled. However, unlike with token cancellation and re-issue, the suspension may be removed or lifted, if said token is subsequently reported as having been recovered, so that the said token is reinstated and can again be used to withdraw cash.

In essence, if a token is suspended from use in this way, security is preserved as the token cannot be used (for example, to meet the security needs of the token provider), and the needs of the customer are met as they can obtain emergency cash without the token. Moreover, beneficially, if a token is suspended rather than cancelled, then the process of cancelling and re-issuing a token may be obviated if the token that was thought to have been lost or stolen is subsequently found.

According to embodiments wherein a token is suspended, the token may subsequently be cancelled if it is not reported as having been recovered within a specified period of time. The time could range from a matter of several hours to several days. In principle, a suspended token may not be cancelled automatically at all; however, in the meantime, the token holder would not have a token, issue of a new token may be delayed and there may be a restriction on the number of times they can withdraw emergency cash. For example, according to some embodiments, the token holder may only be able to withdraw emergency cash once. In other embodiments, they may be permitted, if they contact the token provider and make an appropriate request, to make subsequent emergency cash withdrawals.

In some embodiments, a suspended token is unusable at least while the cash withdrawal code is still validly usable. In this case, if a token provider is informed that a token has been recovered before a respective emergency cash arrangement has been used, a suspension on the token may be removed and the emergency cash withdrawal arrangement may be cancelled (as being no longer needed and to reduce the likelihood of fraudulent use of the emergency cash arrangement). Any attempt by a legitimate customer to use a recovered token, which has not been reported as recovered to the provider and while the emergency cash arrangement is available, would lead to the token and cash withdrawal being rejected.

In addition, or alternatively, the method may include the step of earmarking the agreed amount in a respective customer account when the cash withdrawal code is issued. Earmarking in this sense means that the respective funds are protected, or ring-fenced, so that they cannot be used for any other purpose. In that case, the method may also include removing the earmarking when the cash is dispensed or if the cash is not withdrawn within a predetermined period of time.

The customer may report their token as lost or stolen to a call centre to make a request for a cash withdrawal, wherein the request is received by a call centre. The call centre may be manned by a human operator or may be an automated telephone system, such as an interactive voice response (IVR) system. Alternatively, the requestor may report their token as lost or stolen using a data message, for example sent using a mobile phone or other kind of data messaging device. In any event, the cash withdrawal code may be received from a human operator, an IVR system or via a data message.

The cash withdrawal code may have a limited use. For example, the withdrawal code may be limited in use by one or more of: use in a number of designated ATMs; use in ATMs within a restricted geographic region; use for a restricted period of time; use for a limited number of times; use to withdraw a limited amount of cash; and use to withdraw a pre-agreed or pre-designated amount of cash.

The method may further comprise: entering at least the cash withdrawal code into a cash dispensing machine, which is adapted to receive the input of a cash withdrawal code, without requiring use of a cash dispensing token; validating the cash withdrawal code with reference to issued cash withdrawal codes; and, if the code is valid, dispensing the agreed amount of cash.

The method may then include the step of entering a secondary authentication data into the cash dispensing machine, wherein the secondary authentication data may also be used for validation purposes. For example, the secondary authentication data may comprise the agreed amount of cash to be withdrawn.

According to a second aspect, the present invention provides a system arranged to provide an emergency cash facility when a cash dispensing token is reported as lost or stolen, comprising: a token restriction processor for restricting the subsequent use of a token that is reported as lost or stolen; an emergency cash processor, for determining whether an emergency cash option is available and for generating a code to be used for approved emergency cash withdrawals; an emergency cash code store for storing the generated code; and an earmarking processor, for earmarking funds associated with an approved emergency cash withdrawal.

According to a third aspect, the present invention provides a transaction system, comprising one or more automated cash dispensing machines and a system a system for managing cancellation and re-issue of an ATM token, the cash dispensing machines being adapted to permit withdrawal of cash therefrom without requiring use of a cash withdrawal token (or equivalent), wherein, the system is adapted to refer to the emergency cash code store when emergency cash withdrawal operations are requested at respective cash dispensing machines.

### BRIEF DESCRIPTION OF THE DRAWINGS

Embodiments of the present invention will now be described, by way of example only, with reference to the accompanying drawings, of which:

FIG. 1 is a flow diagram illustrating an exemplary process for restricting use of a lost or stolen ATM card including the provision of emergency cash according to an embodiment of the present invention;

FIG. 2 is a functional block diagram of a card status management system according to an embodiment of the present invention;

FIG. 3 is a functional system diagram of a banking transaction system according to an embodiment of the present invention;

FIG. 4 is a flow diagram showing the steps involved in requesting cancellation of a lost or stolen ATM card an including an option for emergency cash withdrawal;

FIG. 5 is a schematic diagram of an automated cash dispensing machine according to an embodiment of the present invention;

FIG. 6 is a functional block diagram of the components of the machine in FIG. 5; and

FIG. 7 is a flow diagram is a flow diagram showing the steps involved in withdrawing emergency cash according to an embodiment of the present invention.

### DETAILED DESCRIPTION OF THE INVENTION

It is to be understood that any feature described in relation to any one embodiment may be used alone, or in combination with other features described, and may also be used in combination with one or more features of any other of the embodiments, or any combination of any other of the embodiments.

Furthermore, equivalents and modifications not described above may also be employed without departing from the scope of the invention, which is defined in the accompanying claims.

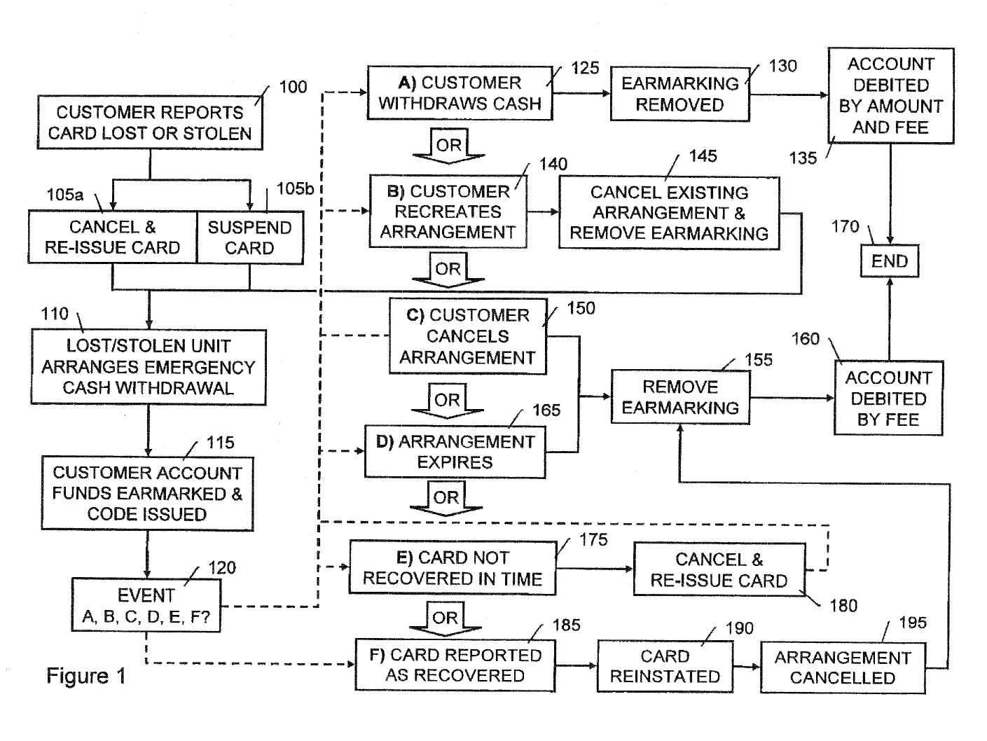

The flow diagram in FIG. 1 illustrates the high level process flow of an embodiment of the present invention. In a first step [100] a customer reports to the bank that their ATM card has been lost or stolen. Typically, customers must report such occurrences to a special lost and stolen department or unit of a bank, which has the capability to cancel and re-issue cards. In response, and after appropriate authentication, the bank places a restriction on the card. According to the present embodiment, restriction can be by way of cancelling the card [105a], so that it cannot be used again, and re-issuing the card (i.e. a replacement card), or suspending the card [105b], so that it cannot be used at least temporarily.

Whether a card is cancelled or suspended will depend on which option is provided by the bank. For example, some banks may only provide the cancellation option. However, other banks may provide both options, which may, for example, be selectable by the customer or by the bank depending on the status of the customer. Of course, some banks may offer only the suspension option.

Next [110], the customer is provided with an option for having the facility to withdraw emergency cash from an ATM without using an ATM card. Obviously, this is not a standard facility as ATMs are traditionally adapted to require a card of some kind as part of an authentication procedure. It is, therefore, important, according to the present embodiment, that the emergency cash process is closely coupled with card restriction process and should, therefore, only be dealt with by the part of the bank that can restrict and/or cancel and re-issue cards.

To be clear, as well as ATM cards, it is expected that other kinds of card, such as a credit card or, more generally, a portable security token, could be used to withdraw cash and could be lost or stolen. Accordingly, reference to “card” herein, unless the context dictates otherwise, encompasses any kind of portable card or token, which may be lost or stolen, and which could interact with an ATM by contact or by contact-less communications to withdraw cash.

The customer clearly has the choice not to accept the offer of emergency cash and, instead, wait for a new card to be issued. This option is not illustrated in the diagram but would simply end the process. However, on the assumption that the customer does wish to have the facility to withdraw emergency cash, according to the present embodiment of the invention, the bank is able to set up an arrangement whereby the customer can withdraw cash from an ATM without requiring an ATM card (or equivalent). The set up requires, first, that the customer has the funds or borrowing facility to cover the required amount of cash and any fee that is charged for the facility. If the customer has the requisite access to funds, then the cash and fee amount is earmarked in the account [115], to ensure that the funds remain unused and available, and the customer is issued with an access code, which is subsequently entered into the ATM to enable the cash withdrawal.

In some embodiments, the option for suspending a card may only be offered if a customer wishes to take advantage of the emergency cash arrangement. In this case, steps [115] and [105b] may occur in reverse order.

The next step in the process can take any one of six different routes, A, B, C, D, E or F depending on the behaviour of the customer. According to the present embodiment, options E and F are typically only available if the card has been suspended [105b] rather than cancelled [105a]. If the customer visits an ATM to withdraw the cash, then a first route, A, occurs in which the customer withdraws the cash [125], the earmarking is removed [130] from the account, the account is debited by the amount of cash withdrawn and a fee [135], and the process then ends [170].

Alternatively, the customer may need to change the arrangements for withdrawing the cash, for example, to withdraw the cash at a different time or at a different place, depending on what restrictions (if any) are placed on the withdrawal. In this case, a second route B occurs, in which the customer contacts the bank in order to re-arrange the facility [140]. The bank cancels the original arrangement, removes the earmarking [145] and the process reverts to make a new arrangement [110]. According to the present embodiment, no fee is charged for this. However, an administrative fee could be charged.

Another option is that the customer cancels the arrangement. In this case, in a third route C, the customer contacts the bank to cancel the arrangement [150], the bank removes the earmarking [155] but charges the fee to the account [160] and the process ends [170].

Alternatively, the customer may simply fail to take advantage of the facility within a specified time, in a fourth route D, in which case the arrangement expires [165], the earmarking is removed [155], the account is debited by the fee [160] and the process ends [170].

According to the present embodiment, an option F is available, when a card has been suspended [105b]. In this case, if the card is not reported as having been recovered within a specified period of time [175], for example within 48 hours, the bank automatically cancels the card, so that it can never be used again, and issues a replacement card [180]. After this, the process can proceed with any of options A-D, as the emergency cash withdrawal arrangement is still active.

Finally, according to the present embodiment, option E is available if the card has been suspended [105b]. If the card is subsequently recovered (i.e. if the card is found again and has not been stolen), the customer can report that fact to the bank [185] and the bank, after the usual verification steps, can reinstate the card [190]. Then the emergency cash arrangement is cancelled [195], the earmarking is removed [155], the account is debited by the fee [160], and the process ends [170].

Clearly, various steps illustrated in and described with reference to FIG. 1 can occur in a different order or in a different way. FIG. 1 is not intended to represent an exhaustive list of variants encompassed by embodiments of the present invention.

The desirability, according to the present embodiment, for the emergency cash process to be closely coupled to a card restriction process requires a significant change to the traditional underlying systems that manage card issuance and cancellation. Historically, card cancellation procedures have been relatively standalone, insofar as there is a low risk to the bank associated with cancelling a card. However, the ability to set us an emergency cash withdrawal requires modification to a number of existing systems, access to existing bank accounts and creation of new systems, interconnects and functions. Moreover, providing card restriction other than cancellation also requires significant modifications. All such additions and modifications are described herein in sufficient detail that the skilled person would be able to implement the changes.

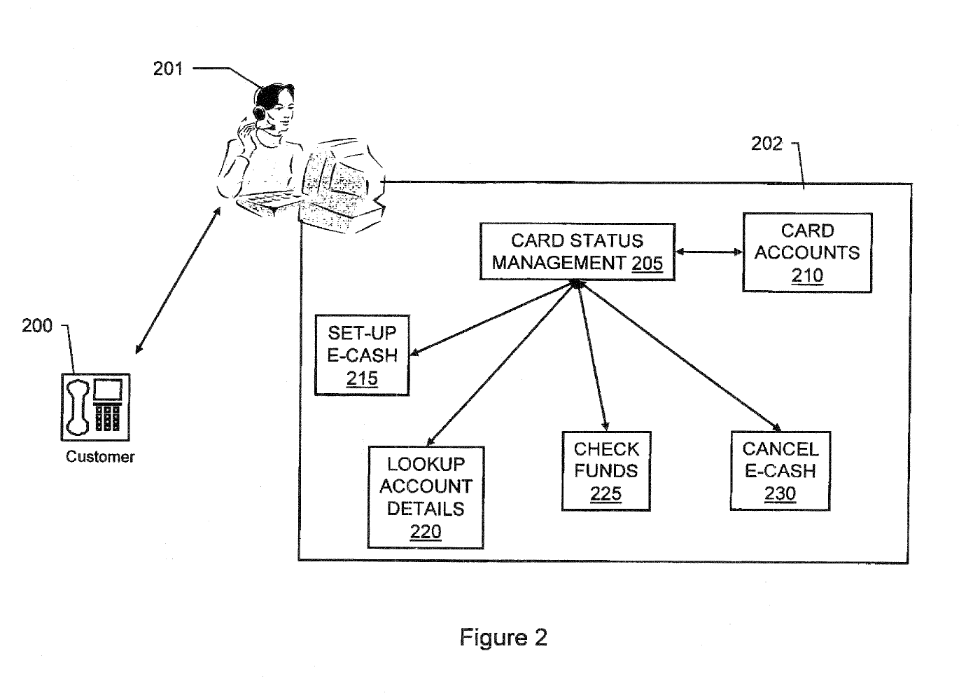

An ATM card status management system 202 according to an embodiment of the present invention is illustrated by way of example in the functional block diagram in FIG. 2. The system is operated by a human operator 201, in this instance, who is contacted by telephone 200 by customers wishing to report lost or stolen ATM cards. The functional block diagram illustrates control and interface functions that are required to interact with existing or new systems in other parts of the banking infrastructure, as will be described in more detail hereinafter. A card status management function 205 is provided to interact with systems that manage customer cards, including card restriction such as suspension, cancellation and re-issue operations via a card accounts function 210. The card cancellation aspects of this function 210 are generally analogous to functionality in exiting systems, and the function provides access to customer card account records. The card status management system is, in addition, extended to interact with a plurality of new functions, which are provided to, in effect, extend the functionality of the card status management system 202. A ‘set-up emergency cash’ interface function 215 is provided so that the card status management function 205 can set up emergency cash facilities in an appropriate database store. A ‘lookup account details’ interface function 220 is provided so that the card status management function 205 can, for example, interact with a customer account master database. A ‘check funds’ interface function 225 is provided to enable the card status management function 205 to interact, for example, with authorisation functions in order to check that there are sufficient funds in a customer account. Finally, a ‘cancel emergency’ cash interface function 230 is provided to enable the card status management function 205, for example, to interact with the aforementioned database store to cancel emergency cash entries that were previously set-up.

In the present context, the term ‘database’ is used broadly and typically encapsulates storage device(s), processor(s) and database application software necessary to store, access and modify database records that are stored in one or more database files on the storage device(s).

Of course, the functionality of the card status management system 202 may be partitioned in many different ways according to other embodiments of the present invention. On the basis of the description provided herein, the skilled person would be able to adapt a card status management system (or equivalent) in any legacy banking system to operate according to embodiments of the present invention.

In general, according to the present embodiment, the card status management system 202, in addition to being able to restrict the use of ATM cards, is provided with the ability to access customer accounts to identify whether a customer has sufficient funds to support an emergency cash transaction, including the ability to earmark funds for that purpose. Hitherto, earmarking of funds has typically only been associated with daily postings (for example, if an automatic debit is know to occur at the end of a particular day, the funds therefor may be earmarked at the beginning of the day). Earmarking of funds for emergency cash according to the present embodiment requires that the respective systems are adapted to apply and remove earmarking in a flexible and immediate manner. For example, it is necessary to apply earmarking immediately at the time the emergency cash facility is set up, and this could be at any time of day or night. It is also necessary to be able to remove earmarking either automatically, for example when the emergency cash is withdrawn or after expiry of a predetermined time, and manually, for example if the emergency cash facility is cancelled or re-arranged by the customer. A further new feature associated with providing an emergency cash facility is ability to charge a fee automatically when the cash is withdrawn or when the facility is cancelled or expires, as illustrated in the flow diagram in FIG. 1.

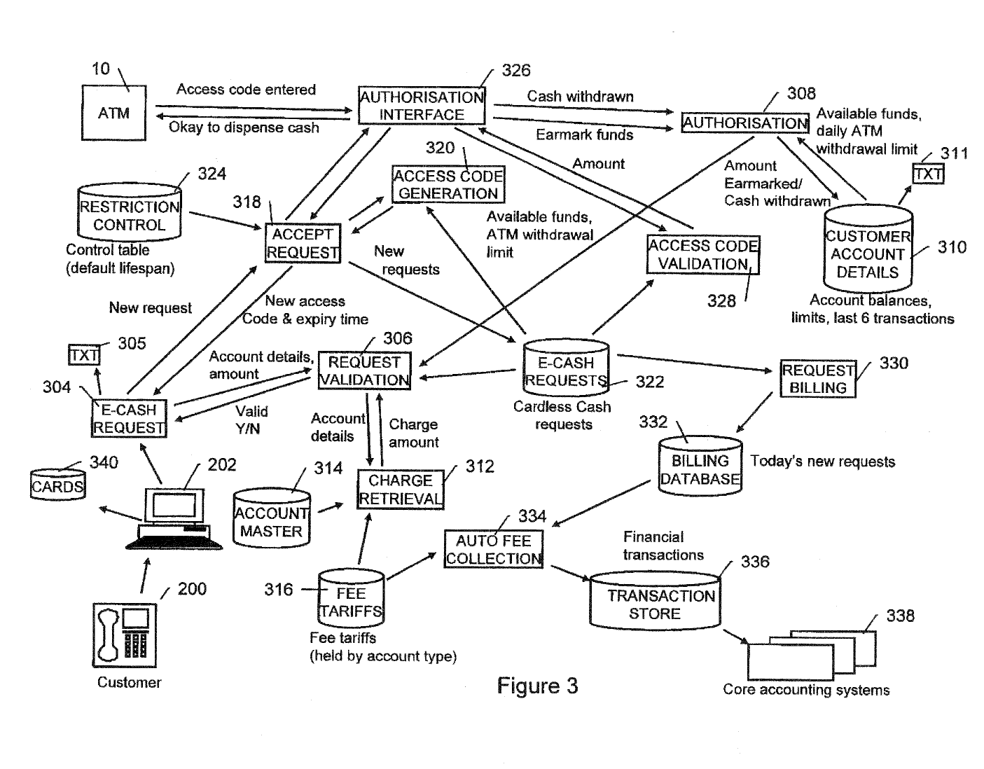

Embodiments of the present invention typically involve two independent operations. A first operation is when a customer contacts their bank to report their card as having been lost or stolen, which can result in the customer accepting the facility to withdraw cash from an ATM without requiring the card. A second operation is when the customer interacts with an ATM, which has been adapted, according to embodiments of the present invention, to withdraw cash without using an ATM card, which operation is referred to herein as an emergency cash withdrawal operation. These two operations will be described in more detail below with reference to the functional system diagram in FIG. 3.

The functional system diagram in FIG. 3 illustrates a set of functions that are involved in setting up and then facilitating an emergency cash withdrawal operation. It will be appreciated that the functions themselves may be arranged as shown, according to the present embodiment, or may be arranged in different ways in other embodiments. In particular, it is expected that most banks and other financial institutions will have legacy data processing systems and that the capability to provide emergency cash would have to be built into the existing systems, each of which would probably vary in configuration. However, the description provided herein will enable the skilled person to adapt any kind of existing system to operate in accord with the present invention. In addition, it will be appreciated that any appropriate computing platform(s) could be used to support the functions illustrated in FIG. 3. For example, in one scenario, all the functions and database components may be arranged on one server or a co-located group of servers, for example running Windows™ Server, UNIX™ or Linux™, in addition to appropriate application and database software. In an alternative scenario, the functions may reside in a distributed computing system, comprising plural interconnected servers in plural places or even in different countries. In another alternative scenario, the system may run on a mainframe computer, for example an IBM mainframe computer.

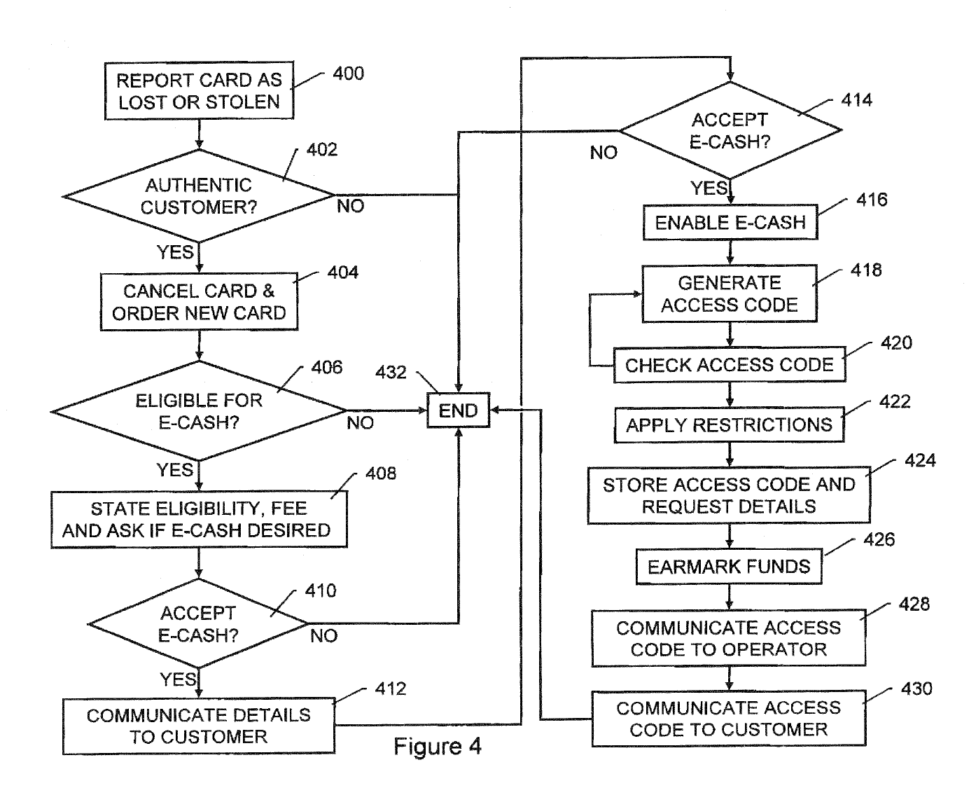

The operation of cancelling an ATM card and setting up a facility to obtain emergency cash will now be described in more detail with reference to the flow diagram in FIG. 4. In this particular example, the card restriction is by way of card cancellation and re-issue. However, it will be appreciated that the operation can easily be adapted to restrict the card by way of suspension.

According to the present embodiment, in a first step [400] a customer contacts their bank by telephone 200 to report that their card has been lost or stolen. It is known that, for reporting lost or stolen cards, a customer typically needs to contact a special department or unit of a bank, which deals with lost and stolen cards. As indicated, this is also the case according to the present embodiment. According to the present embodiment, a human call operator 201 answers the call and establishes that the call relates to a lost or stolen card.

Before taking action to cancel a card, the operator 201 authenticates the customer [402] to ensure that the caller is a genuine customer and not someone attempting to cancel another person's card for malicious purposes or to obtain emergency cash fraudulently. Of course, a reference to a “customer” herein encompasses a card-holder, a designee of the customer or anyone acting on the customer's behalf; for example, the actual customer may be ill or infirm and need assistance. In any event, it is expected that the person reporting the card as lost or stolen will typically be the same person who subsequently withdraws the cash.

In order to authenticate the customer, the customer has to identify himself correctly to the operator 201. The operator 201 interacts with a card status management system 202, which provides the operator with questions to ask the customer, selected from a number of standard questions, and expects in return correct answers, which coincide with information stored in a customer account details database 310. The prompts are communicated to the customer by the operator 201 in order to elicit responses. The prompts typically include personal questions, such as relating to bank account number, customer name, date of birth, mother's maiden name and the like, in accordance with computer prompts. Such authentication procedures are well known.

If the caller is not found to be an authentic customer, then the process ends [432].

Once the customer has been authenticated [404] the operator interacts with the card status management system 202 in order to cancel the card that has been reported as lost or stolen, and issue a new card to be sent to the customer (either their home address or, if they are away from home for a period of a few days or more, to their temporary address). This step is generally analogous to step 105a in FIG. 1; but could equally be analogous to step 105b relating to card suspension. The card status management system 202 interacts with a customer card database 340, in order to cancel and re-issue a card.

Next, having cancelled the card and issued a new card, the card status management system 202 is adapted to determine whether the customer is eligible to receive emergency cash [406]. Eligibility can be dictated by various factors, for example, whether the customer has funds available, whether the customer has a bank account that permits the facility, or in any other appropriate way. If the customer is not eligible, then the process ends [432].

If the customer is eligible then the operator is prompted to inform the customer of the availability of the service [408] and ask whether the customer would like to take advantage of the service. In addition, the operator informs the customer of any fee which would be charged for the service. The fee is determined by a charge retrieval function 312, although, in other embodiments, the fee may be fixed and/or mandatory. The charge retrieval function 312 accesses an account master database 314, which contains information about each kind of account and whether charges for the service are levied against the account type, how large the charges are and how such charges are levied. For example, premium accounts may offer the service for free, whereas standard accounts may require a small payment for the service. Clearly, various other charge structures may be applied, or, indeed, no charges may be applied at all. The charge retrieval function 312 then accesses a fee tariff database 316 in order to retrieve the charge (if required) that is appropriate for the account type.

The customer decides whether to accept the emergency cash facility [410]. If he does not, then the process ends [432]. If, however, the customer does wish to obtain emergency cash, the operator informs the customer of the maximum amount of cash that can be withdrawn, again, according to prompts provided by the card status management system 202, and the customer tells the operator how much cash they wish to withdraw, within any bounds specified, and the operator enters the sum into the card status management system 202. The card status management system 202 responds by interacting with an emergency cash request function 304, which in turn interacts with a request validation function 306, in order to validate the request. The emergency cash request validation function 306 then interacts with an authorisation function 308, which provides access to the customer account details database 310, in order to validate the request.

The amount of cash that can be withdrawn as emergency cash will typically be subject to various restrictions, for example upper and/or lower limits, or a multiple of a certain denomination of currency, in order to maximise the likelihood that the ATM is able to dispense the cash on demand. For example, ATMs in the UK typically hold £10 and £20 (UK pound sterling) paper currency denominations. To the extent that, on occasion, either denomination may have been exhausted from a particular ATM, the minimum withdrawal amount may be set at £20, and other amounts may be limited to multiples of £20, so that the amount can be satisfied by either remaining denomination. Of course, other amounts may be set, for the same reasons, in other jurisdictions in which different denominations are typically dispensed. An upper limit may be set to limit the risk of fraudulent withdrawal and, also, to reduce the chance that the demand cannot be fully met by any particular ATM. In addition, or alternatively, limits may be dependent upon who the customer is or how good their credit history is.

Another way to increase the likelihood that a cash withdrawal succeeds is to specify with ATM (or ATMs) a customer should use. Location information of the ATMs could be provided by phone or text message. This additional service would be useful to ensure that the customer does not attempt withdrawal from an ATM that is not specifically adapted to support card-less cash withdrawals, from an ATM which does not have sufficient funds to supply the requested amount of cash, or from an ATM that is out of service for any reason. The customer can, thereby, avoid travelling to the wrong ATM. Information relating to the capabilities and current status of ATMs could be made available from internal management information systems.

According to the present embodiment, the respective customer account must have sufficient funds (or a fund deficit/overdraft facility) to cover both the specified cash withdrawal amount and any associated service charge. The account balance is obtained from the customer account details database 310.

If there are sufficient funds available for the customer-specified emergency cash withdrawal, then the request is validated [410]. If there are insufficient funds available to fulfil the request, the customer is informed and the procedure ends [432] (although not illustrated as an option) the customer may be informed what their maximum amount is and given the opportunity to specify a lower amount.

After successful validation, the full details of the emergency cash withdrawal, including any fee, are communicated by the operator to the customer [412]. If the customer no longer wishes to continue [414], then the process ends [432]. If the customer is willing to continue [414] then the emergency cash request function 304 interacts with an accept request function 318 [416], in order to facilitate the requested cash withdrawal operation. The accept request function 318 interacts with a cash withdrawal code generation function 320, in order to generate [418] a restricted emergency cash withdrawal code for the cash withdrawal.

According to the present embodiment, the cash withdrawal code is a six-digit random number (although, any other appropriate length of number may be used, depending on the degree of security required). The cash withdrawal code generation function 320 generates the number and accesses a cash request database 322, which stores all such previously-generated random cash withdrawal code numbers, in order to check [420] that the number does not already exist. The numbers are removed from the database 322 as respective cash withdrawals occur or times expire, so, over time, it would be unlikely that all possible numbers would be used at any one time. If the randomly-selected number is already stored, then, the cash withdrawal code generation function 320 keeps generating numbers [418] until a unique one arises.

When a unique cash withdrawal code has been generated, the accept request function 318 accesses a restriction control database 324 in order to identify what restrictions, if any, should be applied [422] to the use of the cash withdrawal code for emergency cash withdrawal. According to the present embodiment, a key restriction is a time period within which the cash withdrawal code must be used. For example, a customer may be informed that he must use the code within one hour, two hours or three hours, after which time the operation may no longer be available. If the period expires before the cash withdrawal code has been used, then the respective records are updated in the cash request database 322 to ensure that the transaction can no longer take place. The cash request database 322 is arranged to carry out such house-keeping matters automatically by monitoring time and evaluating the time remaining for each emergency cash withdrawal code. Such a time-restriction is intended to increase security of the operation. Other times and, indeed, other kinds of restrictions may be applied to the use of the emergency cash withdrawal code. At least some of the restrictions may be specified by the customer. In any event, for example, the emergency cash withdrawal may only be permitted at a particular ATM, or a group of ATMs within a defined, restricted geographic area, for example, in the location (e.g. town, country and/or region) where the customer currently is. Of course, other restrictions may be applied in order to further increase security. Any such pre-existing restrictions would be stored in the restriction control database 324.

The accept request function 318 arranges the emergency cash withdrawal code, the respective amount of cash to be dispensed, the time of the request and the restriction(s), for example the expiry time and date, into a database record, which is then stored [424] in the cash request database 322.

Next [426], the accept request function 318 interacts with the authorisation function 308, via an authentication interface function 326, to earmark the appropriate level of funds in the customer account database 310. For example, if the customer has requested a cash withdrawal of £60 (sixty UK pounds sterling) and the fee is £3, the customer account details database 310 is updated to ensure that no other transaction could deplete the funds below £63. For example, a joint account holder would not be permitted to withdraw more than £10 if only £73 were available for withdrawal from the account. The authorisation interface function 326 normally exists in some form to enable communications, typically via a network, between an ATM 10 and a back-end authorisation system. In this embodiment, the authorisation interfaced function 326 is adapted, in addition, to enable the accept request function 318 to access the back-end authorisation system.

The accept request function 318 communicates [428] the cash withdrawal code to the operator via the emergency cash request function 304 and, finally, the operator communicates [430] the emergency cash withdrawal code to the customer, and the operation ends [432].

Of course, various steps of the process in the foregoing embodiment may be carried out in a different order, or more or fewer steps may be involved. For example, in one variant, it may be preferred that everyone pays a fee for the emergency cash facility. This is a simplified approach, wherein there is no need to establish whether a fee is due and what level the fee is for different classes of customer. Instead, the same fee may be communicated to every customer in step 408. In another variant, the maximum amount any particular customer can request may be established, with reference to their bank account, and communicated to the customer in steps 406 and 408. In this way, there is no need to re-check whether the customer has sufficient funds, obviating the validation part of step 410. Clearly, there are a large number of alternative or additional steps, and orders of processing the steps, that may be applied in embodiments of the present invention.

The foregoing embodiment may be adapted in a number of other ways. For example, in an alternative embodiment, the cash withdrawal code may be communicated by the operator to a mobile phone of the customer, via an SMS text message or the like, produced by a text message function 305. The advantage of such an alternative is that the customer would not need to write the code down or try to remember it. The operator may elicit the mobile phone number from the customer during the telephone call or the mobile phone number may already be stored in the customer account details database 310 as part of the customer's personal profile. In the latter case, security would be enhanced even more. For example, in the event a fraudster were able to acquire a genuine customer's personal information, in order to answer the personal questions and fool the operator into thinking the fraudster was a genuine customer, the fraudster would most likely not also have access to the genuine customer's mobile phone in order to receive the emergency cash withdrawal code.

Alternatively, or in addition, in other embodiments, a human operator is replaced by an automated telephone interactive voice response (IVR) system. Such systems are commonly used by banks to provide customers with automated telephone access to basic account information, such as account balance information and the like. Embodiments of the present invention may be realised as an extension to such a known system, with interactive voice prompts and voice recognition functions designed, respectively, to elicit and receive the appropriate responses from the customer. Again, an emergency cash withdrawal code may be delivered to the customer by the IVR system or by SMS text message, or by any other appropriate means.

In still other embodiments, interactions with the human operator, or even with an IVR system, may be replaced entirely by SMS text communications, or, indeed, by any other kind of messaging protocol with a fixed or mobile communications device, including (but not limited to) a mobile phone, a smart phone, a personal digital assistant, a mobile messaging unit (such as a Blackberry™ unit) or even a personal computer, for example located in an Internet Café™, airport or other public place.

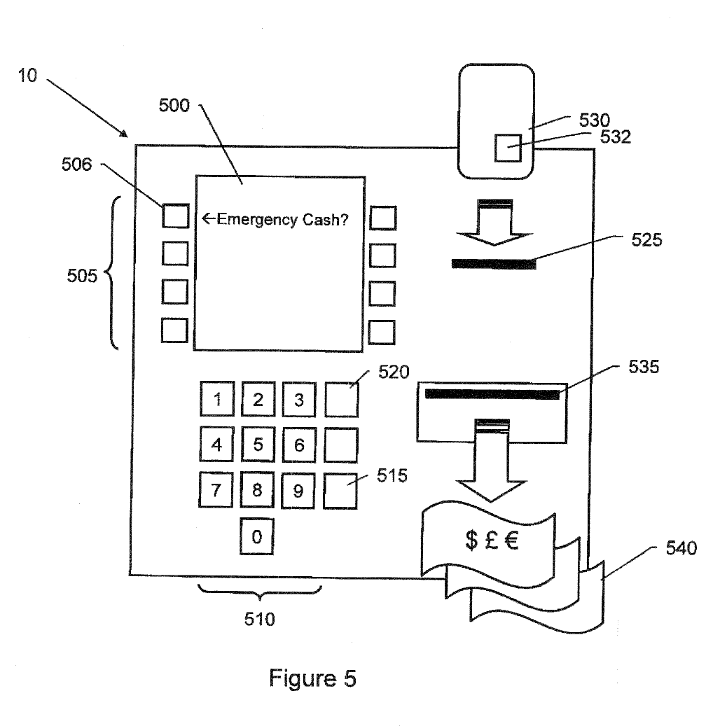

Before describing an emergency cash withdrawal operation, an ATM adapted to facilitate such an operation will first be described with reference to the schematic block diagram in FIG. 5. The diagram in FIG. 5 is a representation of an ATM 10 according to an embodiment of the present invention. The ATM 10 has a generally commonplace appearance, including a display screen 500, plural keys 505 for selecting options displayed on the screen, a numeric keypad 510, a ‘confirm’ or ‘enter’ key 515, a ‘cancel’ key 520, a slot 525 for receiving an ATM card 530, and a slot 535 for dispensing cash 540.

According to the present embodiment, the ATM is adapted so that pressing any of the keys 505 interrupts the idle state of the ATM and causes the display 500 to display a message asking the customer whether they wish to initiate an emergency cash withdrawal operation. Optionally, pressing the enter key could also interrupt the idle state. A respective option appears on the screen, for example as illustrated in FIG. 5, and the customer is prompted to select emergency cash withdrawal by pressing a first key 506. Subsequently, additional instruction messages are displayed as necessary.

In other embodiments, an ATM may be provided with a specific key, a new key or indeed any other kind of input mechanism, such as a key or touch screen, could be assigned with the role of initiating an emergency cash withdrawal. According to some embodiments, the only difference in appearance, which would be noticed by a customer, between the present ATM and known ATMs, might be an ‘Emergency cash’ option sign embossed on the ATM or displayed on the screen. According to other embodiments, there may be no difference in appearance until a key is pressed to interrupt the idle state.

In known ATMs, for the purposes of a normal cash withdrawal, the idle state of the ATM can only typically be interrupted by insertion of an ATM card into the card receiving slot.

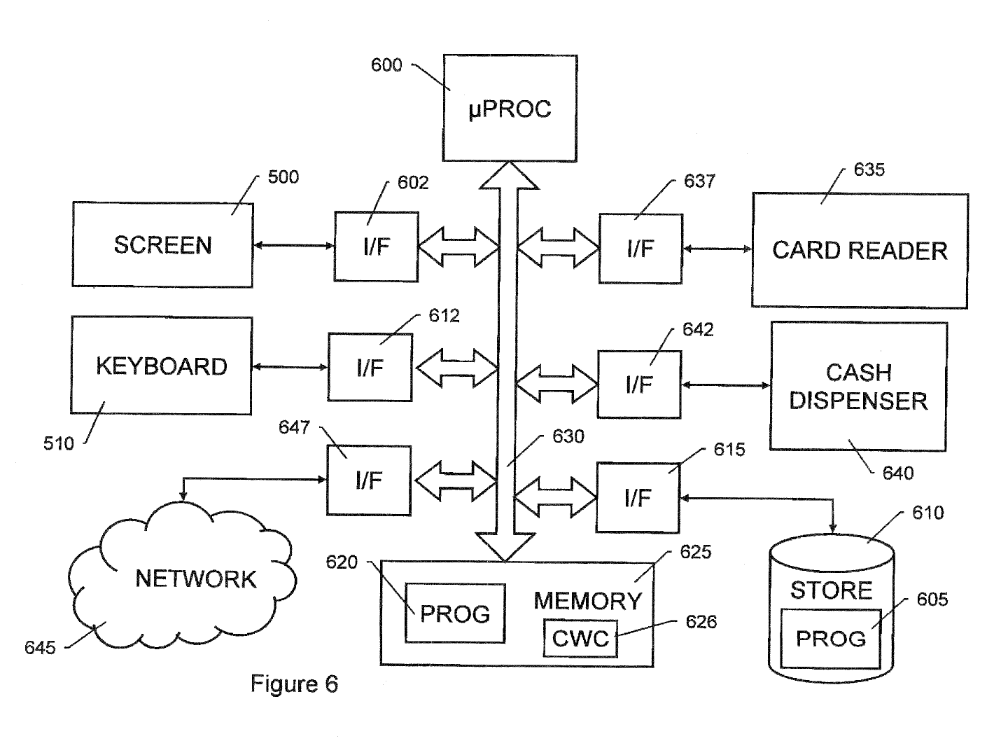

FIG. 6 is a block diagram of the internal components of the ATM illustrated in FIG. 5. As shown, the ATM comprises a microprocessor 600, which is programmed to control the operation of the ATM. The microprocessor 600 is controlled by an ATM software control program 605, which is stored in a permanent store 610, such as a hard disk drive. The microprocessor 600 communicates with the hard disk drive 610 via a disk drive interface 615.

When initialised, the ATM includes a boot operation, which tests for the correct operation of the various components of the ATM and loads the control program 605 from store 610 into a program execution area 620 of a main memory 625, which is, for example, random access memory (RAM). All components are connected to the microprocessor 600 via appropriate standard interfaces, and control and memory buses 630, which are not described herein in detail.

The microprocessor 600 controls the display on the screen 500 via a screen interface 602 and receives input from the various keys 510, 505 via a keypad interface 612. The microprocessor 600 interacts with an ATM card reader apparatus 635 via a card reader interface 637. The card reader apparatus 635 is adapted to interact with known magnetic stripe ATM cards or with known chip cards 530, which contain an embedded microprocessor 532. Of course, the card reader apparatus 635 may be adapted to interact with both kinds of ATM card or, indeed, with new kinds of smart card or other portable personal identity tokens; any of which may include contacts for communicating with the ATM and/or a proximity circuit, such as an RFID circuit, for supporting contact-less communications with the ATM. Such identity tokens include various kinds of cards but, in addition, include other configurations of portable processing device, such as a key fob, mobile phone, or other mobile or portable processing device.

Furthermore, the microprocessor 600 controls a cash dispenser mechanism 640, which is arranged to dispense cash 540 when a requested cash withdrawal has been validated, via a dispenser interface 642. Finally, the microprocessor 600 communicates with other banking systems, for example the cards management database 340 and/or the customer account details database 310, which are connected to a common network 645, via a network interface 647.

As will be described in more detail hereafter, according to the present embodiment, the ATM control program 605 is arranged to bring the ATM out of an idle condition in two different ways. A first way of bringing the ATM out of an idle state is by detecting the insertion of an ATM card 530 into the ATM card slot 525. As already mentioned, a second way of bringing the ATM out of idle is by detecting depression of one of the keys 505, which is assigned as a card-less cash key.

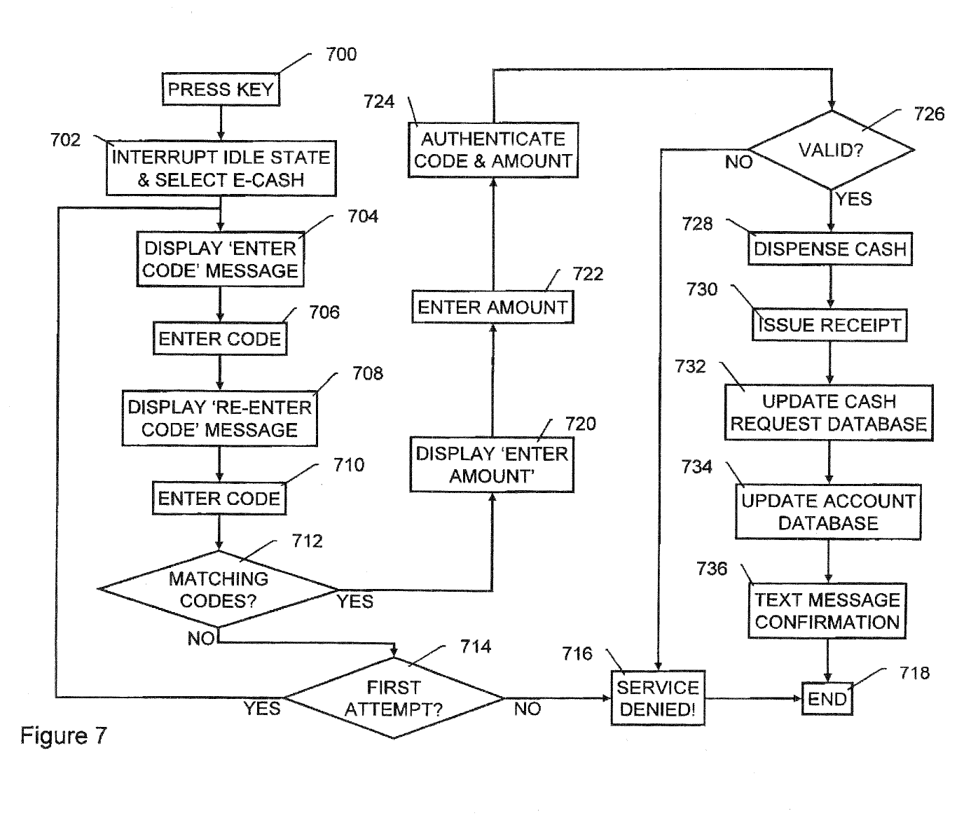

An emergency cash withdrawal operation according to an embodiment of the present invention will now be described with reference to the flow diagram in FIG. 7. For the present purposes, it is assumed that a customer has acquired an emergency cash withdrawal code as described above.

The customer approaches an ATM 10, which meets any restriction criteria to do with location and the like that have been applied to the cash withdrawal code, and presses an emergency cash withdrawal key [700]. The key may be specially designated for emergency cash withdrawals or it may be any other appropriate key(s). This interrupts the idle state of the ATM, the ATM prompts the customer to select if they want an emergency cash withdrawal operation, and the customer selects the emergency cash operation [702]. In response, the ATM displays [704] a message to the customer to enter their cash withdrawal code.

Next, the customer enters [706] their cash withdrawal code, the ATM displays a message to the customer to re-enter their code [708], and the customer re-enters [710] their code. The optional, second re-enter step [708/710] is provided to increase the likelihood that the customer enters the correct code. If the two codes do not match [712], a check is carried out [714] to determine if this is the first attempt to enter the two codes. If it is the first attempt, the process reverts to asking the customer to enter the codes [704]. If the customer has failed in a second attempt to re-enter the codes correctly, then, a message indicating that service is denied is displayed [716] and the process ends [718].

When two matching codes have been entered, on either of the first or the second attempt, the ATM 10 stores the cash withdrawal code in an area of memory 626 and displays a message to the customer [720] to enter the amount of cash to be withdrawn. The customer enters the amount [722]. In response, the ATM stores the amount in an area of memory 626 and interacts [726], via the banking network 645, with the authorisation interface function 326, by forwarding thereto the request for an emergency cash withdrawal, the respective emergency cash withdrawal code and the respective amount. The authorisation interface function 326 interacts with an emergency cash withdrawal code validation function 328, which, in turn, queries the cash request database 322 in order to determine whether the code and amount are valid, and taking into account any respective cash withdrawal code use restrictions. If the cash withdrawal code is not found and/or the amount is not correct, the customer is informed [716] by an appropriate message displayed by the ATM 10 that the service has been denied, and the process ends [718].

If the cash withdrawal code and amount are found in the cash request database 322, the authorisation interface function 326 instructs the ATM 10 to dispense an amount of cash [728] specified by the cash request database 322. The ATM issues a receipt for the transaction [730]. The act of issuing a receipt is accompanied by an entry being added to a transaction log (not shown) of the ATM, which is stored on the hard disk 610, and is available for later inspection, if necessary, for example for fraud investigations or audit purposes.

The authorisation interface function 326 updates [732] the appropriate cash request database 322 records to indicate that the emergency cash withdrawal has taken place, thereby preventing the same withdrawal from being replicated. In addition, the authorisation interface function 326 interacts with the authorisation function 308 in order to update [734] the customer account details database 310, to reflect the fact that the account balance has been reduced by the earmarked cash withdrawal, and to remove the earmarking.

In response to the customer account details database 310 being updated, an optional text message notification of the emergency cash withdrawal transaction is sent to the customer [736]. Clearly, this also acts as a receipt notification. In addition, receiving an unexpected text message, that cash has been withdrawn but not by the customer, would raise an alarm and cause the customer to notify the bank that a fraudulent withdrawal may have occurred. Of course, this kind of text notification would typically be optional as the paper receipt would be sufficient in most cases.

With reference to FIG. 3, the text message is generated (if required) by a text message function 311, which automatically reacts to respective changes on the customer account details database 310. In some embodiments, conveniently, the text message function 310 may be the same function as text message function 305. It is known that some banks can issue text message updates whenever bank transactions occur, and this additional update service could readily be a logical extension of such known systems.

Finally, the operation ends [718].

Various bank account reconciliation operations may arise as a result of the foregoing operations, as illustrated in the diagram in FIG. 3. For example, a request billing function 330 may operate to extract, on a daily basis, details of card-less cash requests stored in the cash request database 322. The request billing function 330 would typically store appropriate request information in a billing database 332. In addition, an automatic fee collection function 334 may inspect the request information in the billing database 332 and interact with the fee tariff database 316 in order to extract the appropriate charge for each stored request. The transactions and respective fee information may be stored in a transaction store 336. Finally, a daily reconciliation operation of a back-end, core accounting system 338 would update a customers' account to reflect charges for the card-less cash withdrawal transactions that they have used. Such reconciliation would be in addition to the standard, daily reconciliation activities that typically would occur between the customer account details database 310 and the core accounting systems 338, in order to ensure that customer account activities for each day are consistently reflected.

The process illustrated in FIG. 7 may be modified in different ways. For example, it may be desirable to increase the degree of authentication by requiring the customer to enter additional information, such as a date of birth or other memorable personal information of the customer. On the other hand, if less security is desired, the requirement to enter the amount, and/or even the requirement to enter the code for a second time, could be dispensed with. Overall, the kind and/or amount of information that needs to be entered by the customer would typically be dictated by the degree of security that is deemed to be appropriate. Indeed, the kind and/or amount of information that needs to be entered could even be varied in dependence upon factors such as how much money is to be withdrawn (where more information could be required for higher amounts) and/or what status the customer has. Another enhancement would be to permit the customer to withdraw only a part of the cash in one withdrawal operation. For example, the customer may wish to have the facility to withdraw £100 but may only wish to carry maximum of £50 at any one time. Accordingly, the system could be adapted to permit withdrawal of less than the agreed amount on a first withdrawal operation and the remainder on a second withdrawal operation. The ability to withdraw the agreed sum in plural withdrawal operations would typically still be subject to restrictions, such as having to withdraw the funds within a specified period of time or from within a defined geographic locale.

In embodiments wherein a card is suspended initially rather than being cancelled, the card status management system 202 interacts with the cards management database 340 in order to suspend the card. In essence, a respective entry for the card in the database 340 is marked as suspended. Then, if the card is subsequently used in an ATM and has not been reported as recovered by the customer, the suspended status is determined by reference to the cards management database 340 (either directly or indirectly) and no cash is delivered to the customer. The ATM may be arranged to keep the card and generate a message that the card is suspended. Alternatively, if the customer contacts the bank and reports that the card has been recovered, the card status management system 202 interacts with the cards management database 340 to reinstate the card so that it can be used once more. In addition, the emergency cash entry is removed from the cash request database, earmarking is removed and the customer is charged with any appropriate fee.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A method of processing a reported loss or theft of a cash dispensing token, comprising:
reporting to a token provider that a token has been lost or stolen;
authenticating the report and restricting the subsequent use of the token; and
issuing a cash withdrawal code, which is usable for withdrawing an agreed amount of emergency cash from a cash dispensing machine without requiring use of a cash dispensing token, and storing the issued cash withdrawal code.

2. The method of claim 1, wherein the step of restricting comprises cancelling said token to prevent any subsequent use thereof.

3. The method of claim 2, including the step of issuing a replacement cash dispensing token.

4. The method of claim 1, wherein the step of restricting comprises suspending said token to prevent subsequent use thereof at least temporarily.

5. The method of claim 4, wherein the suspension is removed, if said token is subsequently reported as having been recovered, so that the said token can be used to withdraw cash.

6. The method of claim 4, wherein said suspended token is cancelled if the token is not reported as having been recovered within a specified period of time.

7. The method of claim 4, wherein said suspended token is unusable at least while the cash withdrawal code is still validly usable.

8. The method of claim 1, including the step of earmarking the agreed amount in a respective customer account when the cash withdrawal code is issued.

9. The method of claim 8 including removing the earmarking when the cash is dispensed or when the cash withdrawal code is no longer validly usable.

10. The method of claim 1, wherein the token is reported as lost or stolen to a call centre.

11. The method of claim 1, wherein the token is reported as lost or stolen via a data messaging network.

12. The method of claim 1, wherein the cash withdrawal code is issued by a call centre.

13. The method of claim 1, wherein the cash withdrawal code is issued via a data message.

14. The method of claim 1, wherein the cash withdrawal code has a limited use.

15. The method of claim 14, wherein the cash withdrawal code is limited in use by one or more of the following:
use in a number of designated ATMs;
use in ATMs within a restricted geographic region;
use for a restricted period of time;
use for a limited number of times;
use to withdraw a limited amount of cash; and
use to withdraw a pre-agreed or pre-designated amount of cash.

16. The method of claim 1, further comprising:
entering at least the cash withdrawal code into a cash dispensing machine, which is adapted to receive the input of a cash withdrawal code, without requiring use of a cash dispensing token;
validating the cash withdrawal code with reference to issued cash withdrawal codes; and
if the code is valid, dispensing the agreed amount of cash.

17. The method of claim 16, including the step of entering a secondary authentication data into the cash dispensing machine, wherein the secondary authentication data is also used for validation purposes.

18. The method of claim 17, wherein the secondary authentication data comprises the agreed amount of cash to be withdrawn.

19. A system arranged to provide an emergency cash facility when a cash dispensing token is reported as lost or stolen, comprising: a token restriction processor for restricting the subsequent use of a token that is reported as lost or stolen; an emergency cash processor, for determining whether an emergency cash option is available and for generating a code to be used for approved emergency cash withdrawals; an emergency cash code store for storing the generated code; and an earmarking processor, for earmarking funds associated with an approved emergency cash withdrawal.

20. The system of claim 19 wherein the token restriction processor is arranged to cancel tokens that are reported as lost or stolen and issue a replacement therefor.
